(19) United States
(12) Patent Application Publication
(10) Pub. No.: US 2026/0340067 A1
(43) Pub. Date: Oct. 29, 2026

(54) ASSISTANCE APPARATUS, ASSISTANCE METHOD, AND STORAGE MEDIUM

(71) Applicant: NEC Corporation, Minato-ku, Tokyo (JP)

(72) Inventor: Riki ETO, Tokyo (JP)

(73) Assignee: NEC Corporation, Minato-ku, Tokyo (JP)

(21) Appl. No.: 19/123,454

(22) PCT Filed: Oct. 31, 2022
(86) PCT No.: PCT/JP2022/040585

§ 371 Date: Apr. 23, 2025

(51) Int. Cl. G06F 17/11

(52) U.S. Cl. CPC G06F 17/11

(57) ABSTRACT

To facilitate determination of a constraint for optimization that uses an objective function, provided is an assistance apparatus (1) including: a variable extraction section (11) that extracts, from training data for use in generation of an objective function, a variable corresponding to a feature of the objective function; a decision tree generation section (12) that generates, with use of the extracted variable and auxiliary information related to the variable, a decision tree for predicting the variable; and an information presentation section (13) that presents a branch condition and a predictive value of the generated decision tree as reference information.

### TECHNICAL FIELD

The present invention relates to an assistance apparatus and the like that assists determination of a constraint for optimization calculation that uses an objective function.

### BACKGROUND ART

Optimization calculation using an objective function is utilized in various technical fields. For example, Patent Literature 1 below discloses a technique related to optimization control for use in industrial processes such as petroleum refining processes and petrochemical processes in order to carry out the operation in an optimum state with use of the optimization that uses an objective function.

### Citation List

### Patent Literature

### Patent Literature 1

Japanese Patent Application Publication Tokukai No. 2015-228151

### SUMMARY OF INVENTION

### Technical Problem

Including the technique disclosed in Patent Literature 1, the optimization calculation that uses an objective function is carried out under a given constraint. Thus, an operator who carries out optimization that uses an objective function needs to set a constraint. However, setting a reasonable constraint requires knowledge and the like about an objective function or the like to be used, so that it might be difficult for some operators to determine a constraint.

An example aspect of the present invention has been made in view of this problem, and an example object thereof is to provide a technique that facilitates determination of a constraint for optimization that uses an objective function.

### Solution to Problem

An assistance apparatus in accordance with an example aspect of the present invention includes: variable extraction means for extracting, from training data for use in generation of an objective function, a variable corresponding to a feature of the objective function; decision tree generation means for generating, with use of (i) the variable extracted by the variable extraction means or a value obtained by substituting the variable into a predetermined mathematical expression and (ii) auxiliary information related to the variable, a decision tree for predicting the variable or the value obtained by substituting the variable into the predetermined mathematical expression; and information presentation means for presenting a branch condition and a predictive value of the decision tree as reference information for determining a constraint in optimization calculation that uses the objective function.

An assistance method in accordance with an example aspect of the present invention includes: extracting, by at least one processor, from training data for use in generation of an objective function, a variable corresponding to a feature of the objective function; a decision tree generation means for generating, by the at least one processor, with use of (i) the extracted variable or a value obtained by substituting the variable into a predetermined mathematical expression and (ii) auxiliary information related to the variable, a decision tree for predicting the variable or the value obtained by substituting the variable into the predetermined mathematical expression; and presenting, by the at least one processor, a branch condition and a predictive value of the decision tree as reference information for determining a constraint in optimization calculation that uses the objective function.

An assistance program in accordance with an example aspect of the present invention is a program that causes a computer to function as: variable extraction means for extracting, from training data for use in generation of an objective function, a variable corresponding to a feature of the objective function; decision tree generation means for generating, with use of (i) the variable extracted by the variable extraction means or a value obtained by substituting the variable into a predetermined mathematical expression and (ii) auxiliary information related to the variable, a decision tree for predicting the variable or the value obtained by substituting the variable into the predetermined mathematical expression; and information presentation means for presenting a branch condition and a predictive value of the decision tree as reference information for determining a constraint in optimization calculation that uses the objective function.

### Advantageous Effects of Invention

According to an example aspect of the present invention, it is possible to facilitate determination of a constraint for optimization that uses an objective function.

### BRIEF DESCRIPTION OF DRAWINGS

FIG. 1 is a block diagram illustrating the configuration of an assistance apparatus in accordance with a first example embodiment of the present invention.

FIG. 2 is a flowchart of an assistance method in accordance with the first example embodiment of the present invention.

FIG. 3 is a diagram for describing the outline of an assistance apparatus in accordance with a second example embodiment of the present invention.

FIG. 4 is a block diagram illustrating the configuration of the assistance apparatus.

FIG. 5 is a diagram illustrating a presentation example of reference information for use in a case where optimization calculation is used in shelf space allocation of products.

FIG. 6 is a diagram illustrating a presentation example of reference information for use in a case where optimization calculation is used to decide how to bet with a betting-ticket.

FIG. 7 is a flowchart of an assistance method in accordance with the second example embodiment of the present invention.

FIG. 8 is a diagram illustrating an example of a computer that executes instructions of a program which is software implementing the functions of the apparatuses in accordance with the example embodiments of the present invention.

### EXAMPLE EMBODIMENTS

### First Example Embodiment

The following description will discuss a first example embodiment of the present invention in detail with reference to the drawings. The present example embodiment is a basic form of an example embodiment described later.

### Configuration of Assistance Apparatus

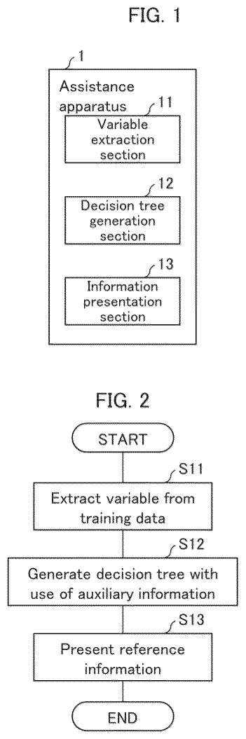

The following description will discuss the configuration of an assistance apparatus 1 in accordance with the present example embodiment with reference to FIG. 1. FIG. 1 is a block diagram illustrating the configuration of the assistance apparatus 1 in accordance with the present example embodiment. As illustrated in the figure, the assistance apparatus 1 includes a variable extraction section 11, a decision tree generation section 12, and an information presentation section 13.

The variable extraction section 11 extracts, from training data for use in generation of an objective function, from training data for use in generation of an objective function, a variable corresponding to a feature of the objective function.

The decision tree generation section 12 generates, with use of (i) the variable extracted by the variable extraction section 11 or a value obtained by substituting the variable into a predetermined mathematical expression and (ii) auxiliary information related to the variable, a decision tree for predicting the variable or the value obtained by substituting the variable into the predetermined mathematical expression.

The information presentation section 13 presents a branch condition and a predictive value of the decision tree as reference information for determining a constraint in optimization calculation that uses the objective function.

As described in the foregoing, the assistance apparatus 1 in accordance with the present example embodiment employs a configuration in which the apparatus includes: the variable extraction section 11 that extracts, from training data for use in generation of an objective function, a variable corresponding to a feature of the objective function; the decision tree generation section 12 that generates, with use of (i) the variable extracted by the variable extraction section 11 or a value obtained by substituting the variable into a predetermined mathematical expression and (ii) auxiliary information related to the variable, a decision tree for predicting the variable or the value obtained by substituting the variable into the predetermined mathematical expression; and the information presentation section 13 that presents a branch condition and a predictive value of the decision tree as reference information for determining a constraint in optimization calculation that uses the objective function. Therefore, according to the assistance apparatus 1 in accordance with the present example embodiment, it is possible to achieve an example advantage of being capable of facilitating determination of a constraint for optimization that uses an objective function.

### Assistance Program

The above functions of the assistance apparatus 1 can be implemented by a program. An assistance program in accordance with the present example embodiment is a program that causes a computer to function as: the variable extraction section 11 that extracts, from training data for use in generation of an objective function, a variable corresponding to a feature of the objective function; the decision tree generation section 12 that generates, with use of (i) the variable extracted by the variable extraction section 11 or a value obtained by substituting the variable into a predetermined mathematical expression and (ii) auxiliary information related to the variable, a decision tree for predicting the variable or the value obtained by substituting the variable into the predetermined mathematical expression; and the information presentation section 13 that presents a branch condition and a predictive value of the decision tree as reference information for determining a constraint in optimization calculation that uses the objective function. According to the assistance program, it is possible to achieve an example advantage of being capable of facilitating determination of a constraint for optimization that uses an objective function.

### Flow of Assistance Method

The following description will discuss the flow of an assistance method in accordance with the present example embodiment with reference to FIG. 2. FIG. 2 is a flowchart illustrating the flow of the assistance method in accordance with the present example embodiment. Here, steps of the training method may be carried out by a processor of the assistance apparatus 1 or by a processor of another apparatus. Alternatively, the steps may be carried out by processors provided in respective different apparatuses.

In S11, at least one processor extracts, from training data for use in generation of an objective function, a variable corresponding to a feature of the objective function. Next, in S12, the at least one processor generates, with use of (i) the variable extracted in S11 or a value obtained by substituting the variable into a predetermined mathematical expression and (ii) auxiliary information related to the variable, a decision tree for predicting the variable or the value obtained by substituting the variable into the predetermined mathematical expression. Then, in S13, the at least one processor presents a branch condition and a predictive value of the decision tree generated in S12 as reference information for determining a constraint in optimization calculation that uses the objective function.

As described in the foregoing, the assistance method in accordance with the present example embodiment employs a configuration in which the method includes: extracting, by at least one processor, from training data for use in generation of an objective function, a variable corresponding to a feature of the objective function; generating, by the at least one processor, with use of (i) the extracted variable or a value obtained by substituting the variable into a predetermined mathematical expression and (ii) auxiliary information related to the variable, a decision tree for predicting the variable or the value obtained by substituting the variable into the predetermined mathematical expression; and presenting, by the at least one processor, a branch condition and a predictive value of the generated decision tree as reference information for determining a constraint in optimization calculation that uses the objective function. Therefore, according to the assistance method in accordance with the present example embodiment, it is possible to achieve an example advantage of being capable of facilitating determination of a constraint for optimization that uses an objective function.

### Second Example Embodiment

### Outline

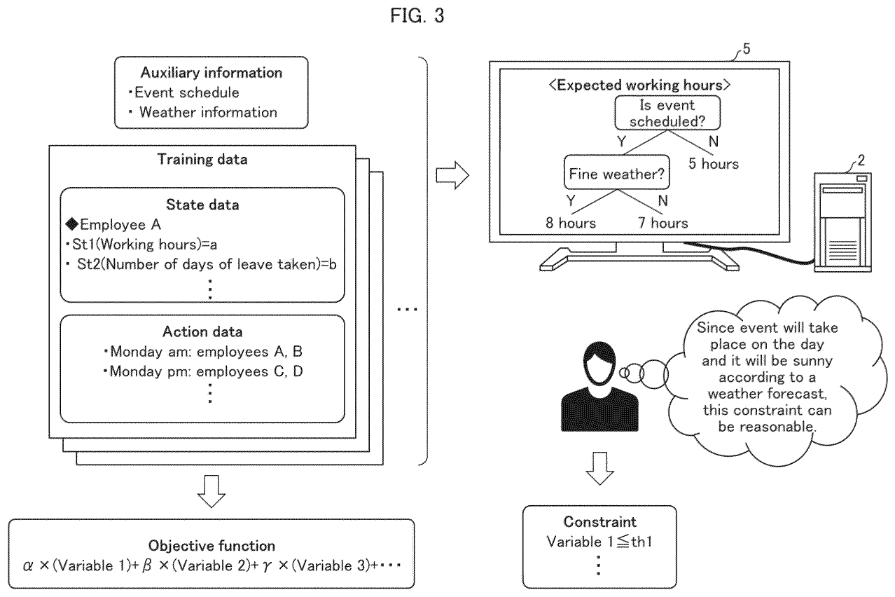

The following description will discuss the outline of an assistance apparatus 2 in accordance with a second example embodiment of the present invention, with reference to FIG. 3. FIG. 3 is a diagram for describing the outline of the assistance apparatus 2 in accordance with the second example embodiment of the present invention. The assistance apparatus 2 is an apparatus that assists optimization calculation that uses an objective function, and more particularly, the assistance apparatus 2 is an apparatus that facilitates determination of a constraint for use in the optimization calculation.

Although FIG. 3 illustrates an example in which the assistance apparatus 2 is a desktop personal computer, this is merely an example. The assistance apparatus 2 may be implemented by a general-purpose computer such as a personal computer or a smartphone, may be implemented as an apparatus that has a main function of assisting determination of a constraint, and may be a stationary apparatus or a portable apparatus.

The assistance apparatus 2 extracts, from training data for use in generation of an objective function, a variable corresponding to a feature of the objective function. Here, if a variable included in the training data is used as a feature of the objective function as it is, the assistance apparatus 2 extracts the variable, whereas, if a feature of the objective function is calculated from one or more variables included in the training data, the assistance apparatus 2 extracts one or more variables for use in the calculation of the feature.

The training data illustrated in FIG. 3 is data in which state data and action data are associated with each other. The action data indicates actions that are preferable to be taken in states indicated by the state data. The training data may be generated based on actions carried out in the past (those can be said to be reasonable actions) and states each being created in response to the corresponding action carried out. In this case, the training data may be reworded as historical data indicating the history of decision making about the actions.

Here, it is assumed that the objective function is generated by inverse reinforcement learning. Therefore, it is sufficient to prepare pieces of the training data as many as necessary for the inverse reinforcement learning. Since the inverse reinforcement learning usually uses a plurality of pieces of training data, the assistance apparatus 2 extracts a variable from each piece of the training data. Note that the objective function is not limited to that being generated by the inverse reinforcement learning, but may be any function that is generated by using the training data. For example, the objective function may be generated by a known machine learning technique such as density ratio estimation.

Various kinds of pieces of action data can be applied. For example, in a case where the objective function creates a schedule, data indicating a schedule conforming to the state indicated by the state data may be adopted as the action data. For example, in the case of creation of a work schedule for each employee, data indicating employees in each time slot as illustrated in FIG. 3 may be used as the action data.

Further, for example, in a case where the objective function is used to carry out resource allocation or matching, data indicating resource allocation or combination conforming to the state indicated by the state data may be adopted as the action data. Similarly, in a case where the objective function is used to carry out order determination, optimal path search, or automatic control, data indicating the order, path, or details on control, conforming to the state indicated by the state data may be adopted as the action data.

Further, the state data may be any data that indicates a state at the time at which an action indicated by the action data is taken, and the state may be expressed by a plurality of variables (St1, St2, . . . ) as illustrated in the figure. For example, in the case of creation of a work schedule for each employee, a variable indicating the cumulative overtime hours of each employee and a variable indicating the maximum daily working hours may be used as the state data. The assistance apparatus 2 extracts such variables from the training data. Here, the state data may be used as a feature of the objective function as it is, and in some cases, the variable may be used to calculate a feature of the objective function.

Next, the assistance apparatus 2 generates, with use of auxiliary information related to the extracted variable, a decision tree for predicting the variable. The auxiliary information may be any information that is related to the extracted variable and is adapted to be used to generate a decision tree. FIG. 3 illustrates an example in which variables indicating working hours are extracted, and accordingly, in the example of FIG. 3, auxiliary information related to working hours is used. Specifically, the auxiliary information illustrated in FIG. 3 includes an event schedule and weather information. That is, here, it is assumed that the working hours increase in the day that an event takes place, and the working hours vary depending on weather conditions (fine weather, rain, high temperature, low temperature, etc.).

Note that the auxiliary information only needs to be information related to the extracted variable, and is not limited to the example described above. For example, various kinds of attribute information related to an employee, such as the employee's position, employment status, age, gender, and number of years of continuous work, may be used as the auxiliary information. Further, for example, a work location or the like may be used as the auxiliary information. Further, in a case where the working hours and the number of days of leave taken are not included in the state data, these may be used as the auxiliary information.

Thus, in creating a schedule by the optimization calculation, various kinds of information related to the allocation target of the schedule can be used as the auxiliary information. Further, various kinds of information about each time slot to be subjected to scheduling (e.g., presence or absence of an event, weather, or the like, in each time slot) may be used as the auxiliary information.

Next, the assistance apparatus 2 generates information indicating a branch condition and a predictive value of the generated decision tree. This information is reference information for allowing the operator to determine a constraint in optimization calculation that uses an objective function generated by the training data. Then, the assistance apparatus 2 presents the generated reference information to the operator (e.g., the operator of the assistance apparatus 2).

The mode of presentation of the reference information is not particularly limited. In the example of FIG. 3, the assistance apparatus 2 generates, as the reference information, an image of the generated decision tree, that is, an image showing branch conditions and predictive values indicated as nodes, which are connected by line segments, and the assistance apparatus 2 displays the generated image on a display apparatus 5.

If it is known what value of the variable extracted from the training data is likely to be obtained under what condition, it is possible to easily determine a reasonable constraint. Thus, according to the assistance apparatus 2, it is possible to facilitate determination of a constraint. In the example of FIG. 3, the operator determines a constraint with reference to the displayed decision tree and the presence or absence of an event in the period for which the schedule is created.

By carrying out the optimization calculation that uses the constraint thus determined and the objective function generated by using the training data, it is possible to infer actions preferable to be taken in respective states. For example, in a case where the action data included in the training data indicates work schedules of the employees, optimization calculation may be carried out using the state data indicating states each affecting the work schedules as input data. Thus, it is possible to infer a schedule preferable to be adopted depending on the state.

The form of the objective function is not particularly limited. For example, in a case where an objective function is generated by inverse reinforcement learning, a mathematical expression in which each feature is multiplied by a weighting value and the obtained values are added may be used as the objective function. In the example of FIG. 3, weighting values of variables 1 to 3, which are features, are α to γ, respectively. It can be said that each feature indicates a factor affecting the actions or a viewpoint emphasized in determination of the actions. Further, each weighting value by which a feature is multiplied indicates how much the factor or viewpoint is emphasized, and is learned by using the training data.

The optimization calculation may be carried out with an optimization solver. As the optimization solver, for example, a common application program such as IBM ILOG CPLEX, Gurobi Optimizer, S CIP, and the like may be used. The assistance apparatus 2 may carry out either or both of the generation of the objective function and the optimization calculation.

### Configuration of Assistance Apparatus

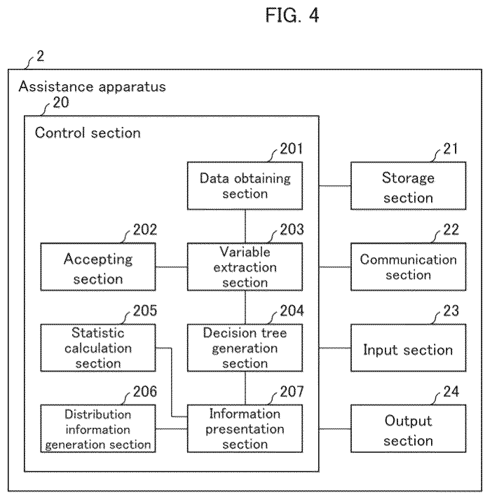

The following description will discuss the configuration of the assistance apparatus 2 in accordance with the present example embodiment with reference to FIG. 4. FIG. 4 is a block diagram illustrating the configuration of the assistance apparatus 2. As illustrated in the figure, the assistance apparatus 2 includes a control section 20 that collectively controls sections of the assistance apparatus 2 and a storage section 21 in which various kinds of data used by the assistance apparatus 2 are stored. Further, the assistance apparatus 2 includes: a communication section 22 that allows the assistance apparatus 2 to communicate with other apparatuses; an input section 23 that receives input of various kinds of data to the assistance apparatus 2; and an output section 24 that allows the assistance apparatus 2 to output various kinds of data. Further, the control section 20 includes a data obtaining section 201, an accepting section 202, a variable extraction section 203, a decision tree generation section 204, a statistic calculation section 205, a distribution information generation section 206, and an information presentation section 207.

The data obtaining section 201 obtains training data for use in generation of an objective function. The data obtaining section 201 also obtains auxiliary information described above. The method of obtaining training data and auxiliary information is not particularly limited, and for example, the data obtaining section 201 may obtain training data and auxiliary information inputted via the input section 23 or may obtain training data and auxiliary information from another apparatus via the communication section 22. Alternatively, a data obtaining section that obtains training data and a data obtaining section that obtains auxiliary information may be separately provided.

The data obtaining section 201 may obtain the auxiliary information by, for example, retrieving a variable extracted from the training data in a predetermined database as a keyword. Further, in a case where the weather information or the event information is used as the auxiliary information, the data obtaining section 201 may, for example, access a website that provides weather information and event information, and obtain weather information and event information of a predetermined period (e.g., the target period in the case of creation of a schedule) as the auxiliary information.

The accepting section 202 accepts specification of a variable for use in generation of reference information. For example, the accepting section 202 may cause the information presentation section 207 to present to the operator variables extracted by the variable extraction section 203, to allow the operator to select one or more variables for use from among the presented variables.

The variable extraction section 203 extracts a variable corresponding to a feature of the objective function from the training data obtained by the data obtaining section 201. For example, if training data in which state data and action data are associated is obtained as in the example of FIG. 3, the variable extraction section 203 may extract variables included in the state data. Note that the variable extraction section 203 may extract the variable in a case where the variable included in the training data is set to the feature of the objective function as it is. Further, in a case where the feature of the objective function is calculated from one or more variables included in the training data, the variable extraction section 203 may extract one or more variables for use in calculation of the feature.

The decision tree generation section 204 generates, with use of the variable extracted by the variable extraction section 203 and auxiliary information related to the variable, a decision tree for predicting the variable. For example, in a case where the variable extraction section 203 extracts a variable indicating the working hours of each employee, the decision tree generation section 204 generates a decision tree for predicting the working hours with use of auxiliary information related to the working hours (e.g., event schedule, weather information, etc.).

Here, in a case where the accepting section 202 accepts specification of a variable for use in generation of reference information, the decision tree generation section 204 generates a decision tree with use of the specified variable. Accordingly, in addition to the example advantage achieved by the assistance apparatus 1 in accordance with the first example embodiment, it is possible to achieve an example advantage of being capable of presenting, to the operator who has specified a variable of interest, reference information generated based on the variable.

The method of generation of a decision tree by the decision tree generation section 204 is not particularly limited. For example, the decision tree generation section 204 may generate a decision tree with an algorithm such as classification and regression tree (CART) and C4.5, or may generate a decision tree by random forest or gradient boosting.

The statistic calculation section 205 calculates a statistic of the variable extracted by the variable extraction section 203. Here, the statistic calculation section 205 may calculate a statistic of a variable for use in generation of reference information, or alternatively, may calculate a statistic of a variable not for use in generation of reference information. For example, in a case where a decision tree for predicting working hours is generated as reference information, the statistic calculation section 205 may calculate a statistic of the working hours, or alternatively, may calculate a statistic of another variable such as the number of days of leave taken.

The statistic may be at least one selected from the group consisting of a mean value, a median value, a maximum value, a minimum value, a mode value, a variance, a deviation, and a standard deviation. For example, in the case of calculating the mean value of “St1” included in the state data in the example of FIG. 3, the statistic calculation section 205 may carry out an operation of dividing the sum of the values of “St1” extracted by the variable extraction section 203 from respective pieces of the training data, by the total number of extracted “St1”.

The distribution information generation section 206 generates distribution information indicating the distribution of the variable extracted by the variable extraction section 203. The distribution information only needs to be information that indicates the distribution of a variable; for example, the distribution information may be a frequency distribution diagram or a scatter diagram of the variable, or may be numerical information such as a combination of a mean and a variance of the variable.

The information presentation section 207 presents, to the operator, a branch condition and a predictive value of the decision tree generated by the decision tree generation section 204 as reference information for determining a constraint in optimization calculation that uses the objective function generated from the training data obtained by the data obtaining section 201. For example, the information presentation section 207 may present the reference information in a form that enumerates branch conditions and predictive values, or alternatively, may present the reference information in a form of displaying an image of the decision tree as illustrated in FIG. 3. The information presentation section 207 also presents, to the operator, the statistic calculated by the statistic calculation section 205 and the distribution information generated by the distribution information generation section 206.

Note that the information presentation section 207 may display the reference information on a display apparatus, may cause an audio output apparatus to output the reference information by voice, or may make a printout of the reference information by a printing apparatus. The apparatus for outputting the reference information may be an apparatus included in the assistance apparatus 2 or may be an apparatus external to the assistance apparatus 2. For example, the information presentation section 207 may cause the output section 24 to output the reference information, or may cause the display apparatus 5 external to the assistance apparatus 2 to output the reference information as illustrated in the example of FIG. 3. The same applies to the statistic and the distribution information.

### Use of Mathematical Expression

Instead of the statistic of the variable extracted by the variable extraction section 203, the decision tree generation section 204 may generate, with use of a value obtained by substituting the variable into a predetermined mathematical expression, a decision tree for predicting the value obtained by substituting the variable into the predetermined mathematical expression. For example, in general optimization calculation, the following constraints may be used as constraints of variable x. Here, a to c are constants.

ax+b>c (1)

ax+b<c (2)

ax+b=c (3)

Thus, the decision tree generation section 204 may generate a decision tree for predicting a value calculated by substituting the variable x extracted by the variable extraction section 203 into, for example, the mathematical expression “ax+b”. This allows the reference information to be presented to the operator for reference in making the constraint expressions as described above.

Further, to calculate a feature of the objective function from one or more variables included in the training data, a decision tree for predicting a value of the feature may be generated. In this case, the variable extraction section 203 extracts one or more variables for use in calculation of the feature, and the decision tree generation section 204 generates a decision tree for predicting a value of the feature calculated by using the variable.

Further, for example, in a case where the objective function is used to produce a production plan of a plurality of items, the variable extraction section 203 may extract a variable indicating the production amounts of the respective items. In this case, the decision tree generation section 204 may generate a decision tree for predicting the sum of the production amounts of the items, that is, the total production amount of all the items. In this case, if it is assumed that the number of items is n (n is an integer of 3 or more), the predetermined mathematical expression is “the production amount of item 1+the production amount of item 2+. . . +the production amount of item n”. Thus, it is possible to present to the operator the reference information for reference in setting the total production amount of all items to the constraint.

Similarly, the statistic calculation section 205 may calculate a statistic of the value obtained by substituting the variable extracted by the variable extraction section 203 into a predetermined mathematical expression. The distribution information generation section 206 may generate distribution information indicating the distribution of the value obtained by substituting the variable extracted by the variable extraction section 203 into a predetermined mathematical expression.

As described in the foregoing, the assistance apparatus 2 employs a configuration in which the apparatus includes the statistic calculation section 205 that calculates a statistic of the variable extracted by the variable extraction section 203 or a statistic of the value obtained by substituting the variable into the predetermined mathematical expression, and the information presentation section 207 also presents the statistic calculated by the statistic calculation section 205. If the statistic of the variable extracted from the training data or the statistic of the value obtained by substituting the variable into the predetermined mathematical expression is known, it is possible to easily determine a reasonable constraint. Thus, according to the assistance apparatus 2, it is possible to achieve an example advantage of being capable of further facilitating determination of a constraint, in addition to the example advantage achieved by the assistance apparatus 1 in accordance with the first example embodiment.

Further, as described in the foregoing, the assistance apparatus 2 employs a configuration in which the apparatus includes the distribution information generation section 206 that generates distribution information indicating a distribution of the variable extracted by the variable extraction section 203 or a distribution of the value obtained by substituting the variable into the predetermined mathematical expression, and the information presentation section 207 also presents the distribution information generated by the distribution information generation section 206. If the distribution of the variable extracted from the training data or the distribution of the value obtained by substituting the variable into the predetermined mathematical expression is known, it is possible to easily determine a reasonable constraint. Thus, according to the assistance apparatus 2, it is possible to achieve an example advantage of being capable of further facilitating determination of a constraint, in addition to the example advantage achieved by the assistance apparatus 1 in accordance with the first example embodiment.

### Switching of Training Data to be Subjected to Extraction

The variable extraction section 203 may sort the training data obtained by the data obtaining section 201 into a plurality of segments and extract a variable from the training data of each segment. In this case, the decision tree generation section 204 generates decision trees corresponding to the respective segments with use of the variables extracted from the training data of respective segments. Here, the decision tree to be generated may be one for predicting the extracted variable or one for predicting the value obtained by substituting the extracted variable into the predetermined mathematical expression. Here, the auxiliary information for use in generation of each decision tree may be the same or different.

In this case, the information presentation section 207 presents, for each segment, the reference information indicating a branch condition and a predictive value of the corresponding decision tree. Accordingly, in addition to the example advantage achieved by the assistance apparatus 1 in accordance with the first example embodiment, it is possible to achieve an example advantage of being capable of providing useful information for determining an appropriate constraint for each segment.

For example, in a case where the training data is data related to a work schedule for the past year of the employees, the variable extraction section 203 may sort the training data into segments of each predetermined period. For example, it is assumed that the variable extraction section 203 sorts the training data by month. In this case, the decision tree generation section 204 generates, with use of the variable extracted from the training data of each month (e.g., working hours), a decision tree for predicting a value of the variable for each month, and the information presentation section 207 presents the decision tree. The information presentation section 207 may present to the operator the decision trees generated by month by, for example, displaying them on a single screen, for example, or alternatively, may present decision trees of some months on a single screen to allow the operator to switch over the months displayed.

### Application Example 1

The assistance apparatus 2 can assist determination of a constraint for various kinds of optimization besides the schedule creation described above. For example, the assistance apparatus 2 may assistance determination of a constraint in determination of optimal resource allocation, determination of optimal order details, creation of an optimum production plan, searching for an optimum path, automatic control, matching, and the like.

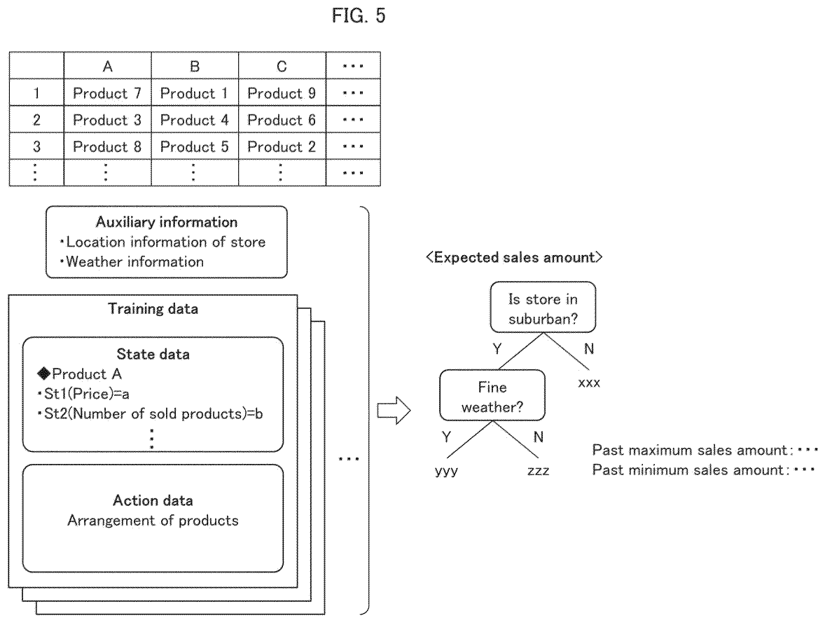

Herein, an example of assisting determination of a constraint for use in a case where optimization calculation is used in shelf space allocation of products, will be described with reference to FIG. 5. FIG. 5 is a diagram illustrating a presentation example of reference information for use in a case where optimization calculation is used in shelf space allocation of products. The shelf space allocation of products is an example of the determination of optimal resource allocation described above.

For example, training data for use in a case where optimization calculation is used to carry out shelf space allocation of products may include variables (St1, St2, . . . ) indicating the prices and the numbers of products sold of the products as the state data, and may include information indicating the arrangement of products as the action data, as illustrated in the figure. For example, in a case where products are placed in shelves arranged in a grid pattern as illustrated in FIG. 5, the positions of the products may be expressed by a combination of the horizontal positions (A, B, C, . . . ) and the vertical positions (1, 2, 3, . . . ). In this case, the position of the product 1 can be expressed as B1, and the position of the product 2 as C3. Similarly, the positions of other products can be each expressed by a combination of an alphabetic character indicating a horizontal position and a numeric character indicating a vertical position.

Although not illustrated, the feature of the objective function generated by using the training data illustrated in FIG. 5 includes the sales amount of the entire shelf. Therefore, in the example of FIG. 5, the training data and auxiliary information are used to generate a decision tree for predicting the sales amount. Since the location information and the weather information of the store is used as the auxiliary information, the branch conditions of this decision tree relate to the location and the weather of the store.

Here, the location information and the weather information represent, for each of the training data, the location information and the weather information of the store from which the training data is obtained. The weather information includes, for example, the temperature, humidity, weather, and the like of a place where the store is located.

Of course, the auxiliary information only needs to be information related to a variable extracted by the variable extraction section 203, and is not limited to these examples. For example, the auxiliary information may be: the category of the product; sales of the product; number of stocks; the position of the shelf in the store; sales of each shelf; and the presence or absence of an event affecting the purchase of products or the number of visitors. Further, in a case where the product prices or the numbers of products sold is not included in the state data, these may be used as the auxiliary information.

In the case of generating the decision tree illustrated in FIG. 5, the variable extraction section 203 extracts, from the training data, variables that are necessary for calculation of the sales amount and are features of the objective function for use in shelf space allocation of products, such as the number of products sold and the sales price of each product. Then, the decision tree generation section 204 calculates the sales amount corresponding to each piece of the training data using the variable extracted from each piece of the training data, and the decision tree generation section 204 generates a decision tree with use of the calculated sales amount and the auxiliary information.

Further, in the example of FIG. 5, statistics calculated by the statistic calculation section 205, that is, specifically, the past maximum sales amount and the past minimum sales amount, are presented together with a decision tree. As such, the information presentation section 207 may present the statistic(s) calculated by the statistic calculation section 205, together with the decision tree. This allows the operator to determine a constraint with reference to both the statistic and the decision tree.

The accepting section 202 may accept the operator's selection for a node of the presented decision tree. In this case, the information presentation section 207 presents the information related to the selected node to the operator. For example, in a case where a node indicating a branch condition is selected, the information presentation section 207 may present the auxiliary information underlying the branch condition. Further, for example, in a case where a node indicating a predictive value is selected, the information presentation section 207 may extract, from the training data, a variable having a value (e.g., a value at which the difference or ratio from the predictive value is not more than a predetermined threshold) close to the predictive value or information related to the variable, and present the extracted variable or information.

For example, in the example of FIG. 5, in a case where the node of the expected sales amount “yyy” is selected, the information presentation section 207 may extract information indicating the arrangement of the products in a case where the sales amount is close to “yyy” from the training data, and present the extracted information. Alternatively, for example, the information presentation section 207 may present a statistic calculated by the statistic calculation section 205 if a node indicating the predictive value is selected.

### Application Example 2

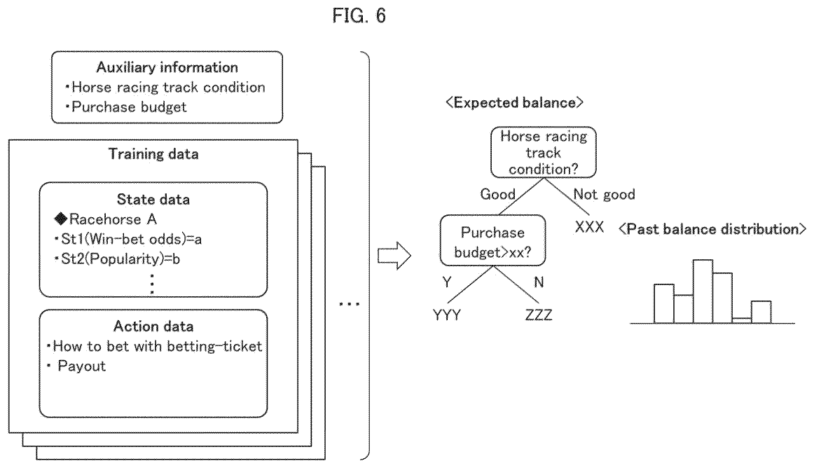

Herein, an example of assisting determination of a constraint for use in a case where optimization calculation is used to decide how to bet with a betting-ticket, will be described with reference to FIG. 6. FIG. 6 is a diagram illustrating a presentation example of reference information for use in a case where optimization calculation is used to decide how to bet with a betting-ticket. How to bet with a betting-ticket is an example of determining the optimal order details described above.

For example, training data for use in a case where optimization calculation is used to make a decision on betting with a winning-horse-betting-ticket (hereinafter, referred to as the “betting-ticket”) may include variables (St1, St2, . . . ) indicating the conditions of each racehorse as the state data, and may include information indicating how to bet with the betting-ticket and the payout as the action data, as illustrated in the figure. How to bet with a betting-ticket can be expressed by using, for example, the type of bet, such as “Win-bet”, “Place-bet”, etc., the purchase price of the ticket of each bet type, and the betted racehorse. Further, the state data may be, besides variables indicating the conditions of racehorse, a variable indicating the conditions of jockey, the conditions of horse racing track, or the conditions of racecourse, or the like.

Although not illustrated, the feature of the objective function generated by using the training data illustrated in FIG. 6 includes a variable indicating the balance of betting-ticket purchase. Therefore, in the example of FIG. 6, the training data and auxiliary information are used to generate a decision tree for predicting the balance. Specifically, since the information indicating the conditions of the horse racing track and the information indicating a purchase budget are used as the auxiliary information, the branch conditions in the decision tree are related to these pieces of information.

The auxiliary information only needs to be information related to a variable extracted by the variable extraction section 203, and is not limited to these examples. For example, the auxiliary information may be: a bracket number, which is a number assigned to each group of horses entered for a race; a horse number, which is a number assigned to each horse entered; racecourse; age of racehorse; loading weight, which indicates the total weight of the jockey, the saddle, and the like; jockey name; horse body weight; amount of change in horse body weight from the previous race; type of race track in the racecourse (grass, dirt, etc.); race distance; and the like. Further, if the Win-bet odds and the popularity (e.g., rank of popularity vote) are not included in the state data, they may be used as the auxiliary information.

In the case of generating a decision tree illustrated in FIG. 6, the variable extraction section 203 extracts, from the training data, variables that are necessary for calculation of a balance and are features of the objective function for determining how to bet with a betting-ticket, such as a variable indicating how to bet with a betting-ticket and a variable indicating the payout. Then, the decision tree generation section 204 calculates the balance by subtracting the purchase price of the betting-ticket from the payout for each piece of the training data, and generates a decision tree with use of the calculated balance and the auxiliary information.

Further, in the example of FIG. 6, distribution information generated by the distribution information generation section 206, that is, specifically, a frequency distribution diagram (histogram) indicating the distribution of past balances, is presented together with the decision tree. As such, the information presentation section 207 may present the distribution information generated by the distribution information generation section 206, together with the decision tree. This allows the operator to determine a constraint with reference to both the distribution information and the decision tree.

Note that the method of determining a constraint in this item is not limited to how to bet with a betting-ticket. The method of determining a constraint in this item may be applied to a case where a voting ticket is bought in another public-supported competitions (bicycle race, motorboat race, motorcycle race, or the like).

### Other Application Examples

For example, in a case where optimization calculation is used to create a production plan, the operation rate of each production apparatus, the production amount of each item, and the like may be adopted as the training data. Then, the variable extraction section 203 may extract, from the training data, a variable indicating, for example, the production amount of each item, and the decision tree generation section 204 may generate, with use of the extracted variables and the auxiliary information affecting the production amount such as the presence or absence of an event and weather information, a decision tree for predicting the total production amount of all items. In this case, the operator can determine a constraint (e.g., a lower limit of the total production amount) with reference to the predictive value of the total production amount in accordance with the presence or absence of an event, the weather, or the like.

Further, for example, in a case where automatic control is carried out by optimization calculation, various measured values (e.g., temperature or pressure) of the apparatus to be controlled, control parameters of the apparatus, or the like, may be adopted as the training data. Then, the variable extraction section 203 may extract, for example, a control parameter from the training data, and the decision tree generation section 204 may generate a decision tree for predicting the control parameters, with use of the extracted control parameter and the auxiliary information affecting the control parameters such as room temperature, humidity, or the like of the room where the apparatus is located. In this case, the operator can determine a constraint (e.g., an upper limit value or a lower limit value of the control parameter) with reference to the predictive value of the control parameter in accordance with the room temperature or humidity.

Further, for example, in a case where optimization calculation is used to carry out matching of persons or objects, the attribute information of the matching object (e.g., age, gender, income, etc.) may be adopted as the training data. Then, the variable extraction section 203 may extract, for example, a variable indicating the income of the subject from the training data, and the decision tree generation section 204 may generate a decision tree for predicting the income with use of the extracted variable and the auxiliary information related to the income such as the residence. In this case, the operator can determine a constraint (e.g., an upper limit and a lower limit of revenue for each residence) with reference to a predictive value of income in accordance with the residence location.

### Flow of Processing

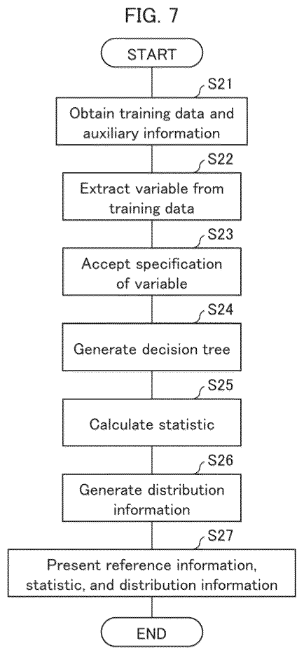

The following description will discuss the flow of processing carried out by the assistance apparatus 2 (assistance method) with reference to FIG. 7. FIG. 7 is a flowchart of the assistance method in accordance with the second example embodiment.

In S21, the data obtaining section 201 obtains training data and auxiliary information for use in generation of an objective function. Note that the timings at which the training data and the auxiliary information are obtained may be different. The training data may be obtained before S22, and the auxiliary information may be obtained before S24.

In S22, the variable extraction section 203 extracts variables from the training data obtained in S21. The variables extracted in S22 are variables corresponding to features of the objective function generated by using the training data obtained in S21 (, the features being one or both of a variable to be used as a feature as it is and a variable to be used in calculation of a feature).

In S23, the accepting section 202 accepts specification of a variable for use in specification of reference information. For example, the accepting section 202 may present to the operator the variables extracted in S22, to accept the specification of one or more variables carried out by the operator. Thus, the variables are narrowed down to one or more variables for use in generation of the reference information in accordance with the one or more variables specified by the operator.

Note that narrowing down to the one or more variables for use in generation of the reference information may be carried out by the variable extraction section 203. For example, the variable extraction section 203 may obtain a weighting value of the objective function corresponding to each extracted variable, and may use a variable(s) each having the weighting value of not less than a predetermined threshold as the one or more variables for use in generation of the reference information. Thus, it is possible to generate the reference information by narrowing down the variables to one or more variables each having a large influence on optimization calculation. Further, for example, the variable extraction section 203 may use the following variables as the one or more variables for use in generation of the reference information: a variable included in a constraint set in the past; a variable that has been used frequently under a constraint set in the past, or a variable of the same kind as these variables. For example, if pieces of information each indicating a variable that has been used in the determined constraint and the type thereof are accumulated, the variable extraction section 203 can narrow down the variables by using the information. The accepting section 202 may allow the operator to specify one or more variables for use in generation of the reference information from among the variables narrowed down in this way.

In S24, the decision tree generation section 204 generates, with use of the auxiliary information obtained in S21, a decision tree for predicting the variable specified in S23. As described above, the decision tree generation section 204 may generate a decision tree for predicting a value obtained by substituting the variable specified in S23 into a predetermined mathematical expression.

In S25, the statistic calculation section 205 calculates a statistic of the variables extracted in S22. Further, in S26, the distribution information generation section 206 generates distribution information of the variables extracted in S22. Here, variables to be subjected to calculation of the statistic may be the variable specified in S23 or may be another variable. The accepting section 202 may accept the specification of a variable to be subjected to calculation of the statistic. Further, the statistic calculation section 205 may calculate a statistic of values obtained by substituting the variables extracted in S22 (or the variable specified by the operator among the variables) into a predetermined mathematical expression. The same applies to the distribution information generation section 206.

In S27, the information presentation section 207 presents a branch condition and a predictive value of the decision tree generated in S24, to the operator as the reference information. The information presentation section 207 may present, together with the reference information, the statistic calculated in S25 and the distribution information generated in S26. This terminates the operation of FIG. 7. Note that the reference information, the statistic, and the distribution information need not be presented at the same time. For example, the information presentation section 207 may present any one of the reference information, the statistic, or the distribution information, in response to the operation or the like of the operator.

### Variations

Any subject may carry out each process described in the foregoing example embodiments, and is not limited to the examples described above. For example, an assistance system having functions similar to those of each of the assistance apparatuses 1 and 2 can be constructed by a plurality of apparatuses that can communicate with each other. For example, an assistance system having functions similar to those of each of the assistance apparatuses 1 and 2 can be constructed by dispersedly providing, in a plurality of apparatuses, blocks illustrated in each of FIGS. 1 and 4. Further, the processes in the flowcharts illustrated in, for example, FIGS. 2 and 5 may be carried out by being shared by a plurality of information processing apparatuses (or processors).

### Software Implementation Example

The functions of part of or all of the assistance apparatuses 1 and 2 can be realized by hardware such as an integrated circuit (IC chip) or can be alternatively realized by software.

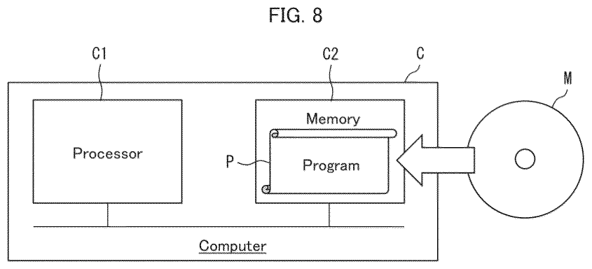

In the latter case, the assistance apparatuses 1 and 2 are realized by, for example, a computer that executes instructions of a program that is software realizing the foregoing functions. FIG. 8 illustrates an example of such a computer (hereinafter, referred to as “computer C”). The computer C includes at least one processor C1 and at least one memory C2. The memory C2 stores a program (assistance program) P for causing the computer C to operate as the assistance apparatuses 1 and 2. In the computer C, the processor C1 reads the program P from the memory C2 and executes the program P, so that the functions of the assistance apparatuses 1 and 2 are realized.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 can be, for example, a flash memory, a hard disk drive (HDD), a solid state drive (SSD), or a combination of these.

Note that the computer C may further include a random access memory (RAM) in which the program P is loaded if the program P is executed and/or in which various kinds of data are temporarily stored. The computer C may further include a communication interface via which data is transmitted to and received from another apparatus. The computer C may further include an input-output interface for connecting input-output apparatuses such as a keyboard, a mouse, a display and a printer.

The program P can be recorded in a non-transitory tangible storage medium M from which the computer C can read the program P. The storage medium M can be, for example, a tape, a disk, a card, a semiconductor memory, a programmable logic circuit, or the like. The computer C can acquire the program P via the storage medium M. The program P can be transmitted via a transmission medium. The transmission medium can be, for example, a communications network, a broadcast wave, or the like. The computer C can acquire the program P also via such a transmission medium.

### Additional Remark 1

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following supplementary notes.

### Supplementary Note 1

An assistance apparatus including: variable extraction means for extracting, from training data for use in generation of an objective function, a variable corresponding to a feature of the objective function; decision tree generation means for generating, with use of (i) the variable extracted by the variable extraction means or a value obtained by substituting the variable into a predetermined mathematical expression and (ii) auxiliary information related to the variable, a decision tree for predicting the variable or the value obtained by substituting the variable into the predetermined mathematical expression; and information presentation means for presenting a branch condition and a predictive value of the decision tree as reference information for determining a constraint in optimization calculation that uses the objective function.

### Supplementary Note 2

The assistance apparatus according to Supplementary note 1, further including statistic calculation means for calculating a statistic of the variable extracted by the variable extraction means or a statistic of the value obtained by substituting the variable into the predetermined mathematical expression, wherein the information presentation means also presents the statistic.

### Supplementary Note 3

The assistance apparatus according to Supplementary note 1 or 2, further including distribution information generation means for generating distribution information indicating a distribution of the variable extracted by the variable extraction means or a distribution of the value obtained by substituting the variable into the predetermined mathematical expression, wherein the information presentation means also presents the distribution information.

### Supplementary Note 4

The assistance apparatus according to any one of Supplementary notes 1 to 3, further including accepting means for accepting specification of the variable, wherein the decision tree generation means generates the decision tree with use of the specified variable.

### Supplementary Note 5

The assistance apparatus according to any one of Supplementary notes 1 to 4, wherein the training data is sorted into a plurality of segments, the variable is variables extracted from the respective segments, and, with use of the variables, the decision tree generation means generates decision trees corresponding to the respective segments, and the information presentation means presents, for each of the plurality of segments, a branch condition and a predictive value of the decision tree.

### Supplementary Note 6

An assistance method including: extracting, by at least one processor, from training data for use in generation of an objective function, a variable corresponding to a feature of the objective function; generating, by the at least one processor, with use of (i) the variable extracted by the variable extraction means or a value obtained by substituting the variable into a predetermined mathematical expression and (ii) auxiliary information related to the variable, a decision tree for predicting the variable or the value obtained by substituting the variable into the predetermined mathematical expression; and presenting, by the at least one processor, a branch condition and a predictive value of the decision tree as reference information for determining a constraint in optimization calculation that uses the objective function.

### Supplementary Note 7

An assistance program that causes a computer to function as: variable extraction means for extracting, from training data for use in generation of an objective function, a variable corresponding to a feature of the objective function; decision tree generation means for generating, with use of (i) the variable extracted by the variable extraction means or a value obtained by substituting the variable into a predetermined mathematical expression and (ii) auxiliary information related to the variable, a decision tree for predicting the variable or the value obtained by substituting the variable into the predetermined mathematical expression; and information presentation means for presenting a branch condition and a predictive value of the decision tree as reference information for determining a constraint in optimization calculation that uses the objective function.

### Additional Remark 3

Furthermore, some of or all of the above example embodiments can also be expressed as below. An assistance apparatus including at least one processor, the at least one processor carrying out: a process of extracting, by at least one processor, from training data for use in generation of an objective function, a variable corresponding to a feature of the objective function; a process of generating, by the at least one processor, with use of (i) the extracted variable or a value obtained by substituting the variable into a predetermined mathematical expression and (ii) auxiliary information related to the variable, a decision tree for predicting the variable or the value obtained by substituting the variable into the predetermined mathematical expression; and a process of presenting, by the at least one processor, a branch condition and a predictive value of the decision tree as reference information for determining a constraint in optimization calculation that uses the objective function.

It should be noted that this assistance apparatus may further include a memory, which may store therein the assistance program for causing the at least one processor to carry out the process of extracting the variable, the process of generating the decision tree, and the process of presenting the reference information. Alternatively, the assistance program may be stored in a computer-readable, non-transitory, tangible storage medium.

### REFERENCE SIGNS LIST

1 Assistance apparatus
11 Variable extraction section
12 Decision tree generation section
13 Information presentation section
2 Assistance apparatus
202 Accepting section
203 Variable extraction section
204 Decision tree generation section
205 Statistic calculation section
206 Distribution information generation section
207 Information presentation section

What is claimed is:

1. An assistance apparatus comprising at least one processor, the at least one processor carrying out:
a variable extraction process of extracting, from training data for use in generation of an objective function, a variable corresponding to a feature of the objective function;
a decision tree generation process of generating, with use of (i) the variable extracted in the variable extraction process or a value obtained by substituting the variable into a predetermined mathematical expression and (ii) auxiliary information related to the variable, a decision tree for predicting the variable or the value obtained by substituting the variable into the predetermined mathematical expression; and
an information presentation process of presenting a branch condition and a predictive value of the decision tree as reference information for determining a constraint in optimization calculation that uses the objective function.

2. The assistance apparatus according to claim 1, the at least one processor further carrying out a statistic calculation process of calculating a statistic of the variable extracted in the variable extraction process or a statistic of the value obtained by substituting the variable into the predetermined mathematical expression,
wherein in the information presentation process, the at least one processor also presents the statistic.

3. The assistance apparatus according to claim 1, the at least one processor further carrying out a distribution information generation process of generating distribution information indicating a distribution of the variable extracted in the variable extraction process or a distribution of the value obtained by substituting the variable into the predetermined mathematical expression,
wherein in the information presentation process, the at least one processor also presents the distribution information.

4. The assistance apparatus according to claim 1, the at least one processor further carrying out an accepting process of accepting specification of the variable,
wherein in the decision tree generation process, the at least one processor generates the decision tree with use of the specified variable.

5. The assistance apparatus according to claim 1, wherein
the training data is sorted into a plurality of segments, the variable is variables extracted from the respective segments, and, with use of the variables, in the decision tree generation process, the at least one processor generates decision trees corresponding to the respective segments, and
in the information presentation process, the at least one processor presents, for each of the plurality of segments, a branch condition and a predictive value of the decision tree.

6. An assistance method comprising:
extracting, by at least one processor, from training data for use in generation of an objective function, a variable corresponding to a feature of the objective function;
generating, by the at least one processor, with use of (i) the extracted variable or a value obtained by substituting the variable into a predetermined mathematical expression and (ii) auxiliary information related to the variable, a decision tree for predicting the variable or the value obtained by substituting the variable into the predetermined mathematical expression; and
presenting, by the at least one processor, a branch condition and a predictive value of the decision tree as reference information for determining a constraint in optimization calculation that uses the objective function.

7. A computer-readable non-transitory storage medium that stores a program for causing a computer to function as an assistance apparatus, the program causing the computer to carry out:
a variable extraction process of extracting, from training data for use in generation of an objective function, a variable corresponding to a feature of the objective function;
a decision tree generation process of generating, with use of (i) the variable extracted in the variable extraction process or a value obtained by substituting the variable into a predetermined mathematical expression and (ii) auxiliary information related to the variable, a decision tree for predicting the variable or the value obtained by substituting the variable into the predetermined mathematical expression; and
an information presentation process of presenting a branch condition and a predictive value of the decision tree as reference information for determining a constraint in optimization calculation that uses the objective function.
